(19) United States
(12) Patent Application Publication
(10) Pub. No.: US 2017/0232978 A1
(43) Pub. Date: Aug. 17, 2017

(54) Method and device for preventing fast changes of the internal pressure in an enclosed space

(71) Applicant: ThyssenKrupp Transrapid GmbH, Kassel (DE)

(72) Inventors: Qinghua Zheng, Taufkirchen (DE); Florian Dignath, Muenchen (DE)

(21) Appl. No.: 15/481,610

(22) Filed: Apr. 7, 2017

Related U.S. Application Data
(63) Continuation-in-part of application No. 12/593,017, filed on Sep. 25, 2009.

(30) Foreign Application Priority Data
Apr. 18, 2007 (DE) 102007019014.1

(51) Int. Cl. B61D 27/00; B66B 1/28; B66B 11/02

(52) U.S. Cl. CPC B61D 27/0009; B66B 11/024; B66B 1/28; B64D 13/04

(57) ABSTRACT

A control device prevents rapid changes in an internal pressure of an enclosed space induced by an external environment. The control device includes a first pressure sensor in the enclosed space, a second pressure sensor outside the enclosed space, a pressurized container and a vacuum container in the enclosed space and a regulator to at least partially compensate for rapid pressure changes in the enclosed space detected in response to signals generated by the first and second pressure sensors. If the detected rapid pressure change is a decrease in the internal pressure in the enclosed space, the regulator controls the pressurized container to provide a controlled supply of air and if the detected rapid pressure change is an increase in the internal pressure in the enclosed space, the regulator controls the vacuum container to remove of air from the enclosed space.

### CROSS-REFERENCE TO A RELATED APPLICATION

The invention described and claimed hereinbelow is a continuation-in-part application of U.S. patent application Ser. No. 12/593,017, filed Sep. 25, 2009 (“the parent application”) The parent application also is described in PCT/DE2008/000464, filed on Mar. 20, 2008 and German patent application DE 10 2007 109 014.1, filed Apr. 18, 2007. The German Patent Application, the subject matter of which is incorporated herein by reference, provides the basis for a claim of priority of invention under 35 U.S.C. 119(a)-(d).

### BACKGROUND OF THE INVENTION

The present invention relates to a control device, and a method of using such a control device, for preventing rapid changes in an internal pressure of an enclosed space induced by an external environment.

In enclosed passenger compartments of various vehicles, which can reach high maximum speeds, such as railway trains, magnetic levitation trains, elevator systems and aircraft, without limitation, undesired pressure changes may occur during operation. In the case of railway trains and magnetic levitation trains, this may be caused, e.g., by traveling rapidly through narrow tunnels, or by trains passing one another on nearby tracks, in which cases pressure waves are produced. Since pressure changes of this type are perceived by passengers at a certain minimum rate of pressure change as uncomfortable pressure in the ears, the International Union of Railways, UIC, instituted guidelines (“Measures to Ensure the Technical capability of High-Speed Trains; UIC 660; ISBN 2-7461-0215-3) that define comfort levels for pressure changes of this type.

According to UIC 660, the following limits are defined for pressure change
Δt=1 s: Δpₘₐₓ=500 Pa
Δt=3 s: Δpₘₐₓ=800 Pa
Δt=10 s: Δpₘₐₓ=1000 Pa
   UIC 660 makes clear that both the rate of the pressure change on the one hand and the absolute change in the pressure on the other hand are coupled with respect to the convenience of a passenger. For example, the rate of the pressure change as a quotient of pressure and time is not as significant as the influence of the convenience of a passenger is as a non-liner function. For example, audible sound waves correspond to a high rate of pressure change without any inconvenience of the passenger.

Similar problems arise in aircraft if flight altitudes change rapidly, and in rapidly ascending and descending elevator cabins, since air pressure changes with altitude.

To prevent this problem, it is known in the case of railways, in particular high speed trains, to design the passenger compartments to be as pressure-tight as possible, to limit the rate of pressure changes in the interior spaces that occur due to changes in the external pressure to such an extent that the pressure changes are not perceived by the passengers as being uncomfortable. However, to create the level of pressure-tightness required, it is necessary to equip all doors, windows, passages between passenger cars, etc., with seals, to equip air conditioning units or the like with the closeable valves which are used to supply or remove air, and which are closed when a tunnel is entered and are then reopened when the tunnel is exited, and to design the structure of the passenger car to have as few openings as possible. The same applies for magnetic levitation trains. Another possibility for preventing uncomfortable pressure changes from occurring is to select the ratio of the tunnel cross section to the vehicle cross section to be sufficiently large, and to permit trains to pass one another only if the tracks are sufficiently far apart, or to avoid passing in tunnels altogether, to reduce the size of the pressure waves.

In the case of aircraft construction, air pressure in the passenger compartments is regulated using powerful ventilators which are installed at the air inlets and outlets. Controls of this type are designed to provide continual pressure equalization, and they would require disproportionately large ventilators to handle very rapid pressure changes of the type, e.g., that occur when a train passes through a tunnel; said ventilators would also need to be able to react to rapid changes in external pressure in a highly dynamic manner.

### SUMMARY OF THE INVENTION

A technical problem addressed by the present invention is minimize internal pressure changes that occur rapidly within enclosed spaces to ensure that persons situated in the enclosed spaces do not experience discomfort.

The present invention operates to at least partially compensate for a pressure change, e.g., a rapid pressure change in the form of an underpressure, which is induced in an enclosed space via an external source, by supplying a corresponding quantity of air into the space. In an analogous manner, the invention at least partially compensates for a rapid pressure change, e.g., in the form of an overpressure, by removing a corresponding quantity of air from the enclosed space when an overpressure suddenly occurs. The internal pressure is regulated in such a manner that the pressure is changed at a preselected rate. As a result, it is possible to protect the persons situated in the space from unpleasant pressure changes that impair riding comfort, whether it be in trains, airplanes, elevators, etc., without limitation. According to an embodiment of the present invention, air is supplied or removed using a pressurized container or a vacuum container, thereby eliminating the use of complex fans, pumps, or the like.

Pressure (P) is the force applied to a surface of an object per unit area over which the force is distributed (Pa=1 N/m²; 1 kg/(m*s²); 1 J/m³), gauge pressure is the pressure relative to the ambient pressure. Gauge pressure is zero-referenced against ambient air pressure, so it is equal to absolute pressure minus atmospheric pressure. Negative signs are usually omitted. To distinguish a negative pressure, the value may be appended with the word “vacuum” or the gauge may be labeled a “vacuum gauge.”

P(t) defines pressure as a function of time (t). What is important with respect to the comfort of a passenger in a closed compartment is the pressure change Δp=p(t)−p(t₀), where p(t₀) is a reference pressure in comparison with a time interval Δt=t−t₀. Hence, the ratio Δp/Δt is not constant and is a function of Δt. As used herein, “rapid pressure change” is defined as a change in pressure that is greater than 500 Pa/sec. within 1 sec., greater that 800 Pa within 3 sec. or grater that 1000 within 10 sec. Please note that as the influence on the convenience of the passenger is not a linear function, it is not possible to scale the values. Likewise, a pressure change of 500 Pa occurring over 1 second or more would not be a rapid pressure change, but if same occurred in less than 1 second, it would be a rapid pressure change, i.e., a pressure change of 500 Pa over a 1/10 sec. and 1/100 sec, would be rapid pressure changes (rapid change of pressure over time).

### BRIEF DESCRIPTION OF THE DRAWING FIGURES

The invention is explained in greater detail in the following drawings with reference to at least one exemplary embodiment. Schematically in the drawings:

FIG. 1 is a schematic depiction of an embodiment of a complete internal pressure regulator for an enclosed space;

FIG. 2 shows a block diagram of a control device for an internal pressure control according to FIG. 1;

FIG. 3 is a schematic depiction of an embodiment of a partial internal pressure regulator for an enclosed space;

FIG. 4 shows, as an example, possible courses of pressure levels that occur in the passenger compartment of a rail bound vehicle as it passes through a tunnel;

FIG. 5 shows, in a depiction similar to that shown in FIG. 4, the course of pressure in a relatively poorly sealed space while using internal pressure regulation according to the present invention;

FIG. 6 shows, in a depiction similar to that shown in FIG. 5, the course of pressure in a relatively well sealed space while using internal pressure regulation according to the present invention; and

FIG. 7 shows, as an example, fluctuating pressure within an enclosed space embodying an elevator cabin, as the cabin ascends over time.

### DETAILED DESCRIPTION OF THE PREFERRED EMBODIMENTS

The following is a detailed description of example embodiments of the invention depicted in the accompanying drawing. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

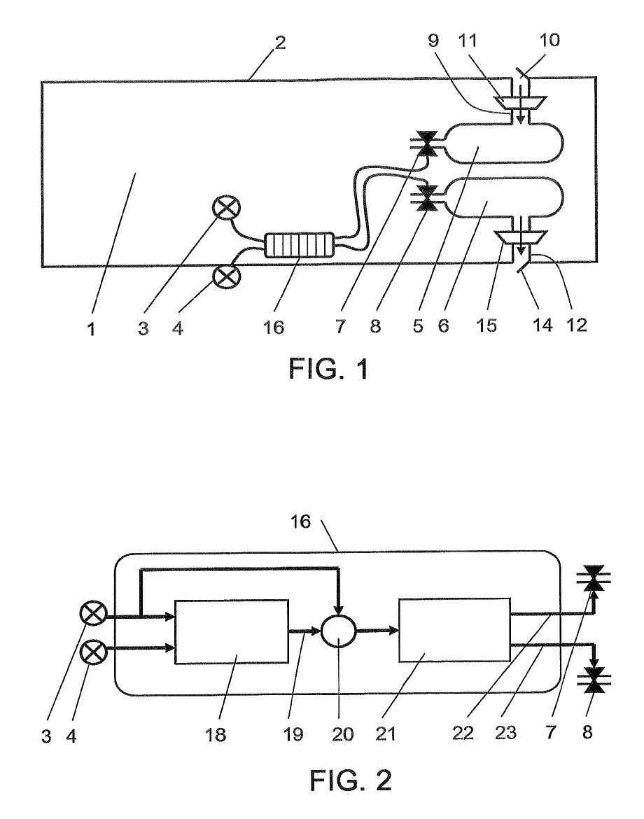

FIG. 1 is a schematic depiction of an embodiment of the present invention which is currently considered to be the best, and which makes it possible to regulate internal pressure completely, regardless of whether the external air pressure is greater or less than the air pressure in the space under consideration. In FIG. 1, it is assumed, for example, that the air pressure in an enclosed space 1 should be regulated; enclosed space 1 is the passenger compartment of a high-speed train, e.g., a magnetic levitation train, and it is enclosed by vehicle wall 2. “Enclosed” is understood to mean that vehicle wall 2 forms a housing that encloses space 1 when not-shown windows and doors are closed; the housing is sealed tight all around, except for any leaks that are typically present, and except for any ventilation openings that may be present for air conditioning units or the like. Depending on its quality, age, or other particulars, space 1 may of course be well sealed or not very well sealed, as will become clear in the description that follows.

As shown in FIG. 1, at least one pressure sensor 3 and 4 is located in space 1, and one is located outside thereof (referred to here as the “environment external to space 1”), via which the air pressure in space 1 (referred to hereinbelow as “internal pressure”) and the air pressure in the external environment (referred to hereinbelow as “external pressure”) are measured. Furthermore, at least one pressurized container 5 and one vacuum container 6 are provided, both of which may be located directly inside space 1 or outside of space 1, e.g., in an adjacent space or in a region separate from space 1, but which, like space 1, is a component of the vehicle under consideration.

Pressurized container 5 includes a control valve 7, via which compressed air may flow out of pressurized container 5 and into space 1, possibly via at least one connected line. Vacuum container 6 includes a control valve 8, via which air may flow out of space 1 and into vacuum container 6, possibly via at least one connected line. The rate at which air flows through control valves 7, 8 may be adjusted by controlling the opening cross section of control valves 7, 8, preferably with the aid of electrical signals which are transmitted to an electrical or electromagnetic actuating component of control valves 7, 8.

Furthermore, pressurized container 5 is connected via a line 9 to an opening which is formed in vehicle wall 2 and leads to the external environment; the opening may be closed in a pressure-tight manner using a flap 10 or the like. A ventilator or compressor 11 is located in line 9, using which pressure container 5 may be filled, with flap 10 open, with compressed air until a preselected overpressure is attained. Vacuum container 6 is connected via a line 12 to an opening which is formed in vehicle wall 2 and leads to the external environment; the opening may be closed in a pressure-tight manner using a flap 14 or the like. A pump 15 is located in line 12, using which vacuum container 6 may be evacuated, with flap 14 open, until a preselected underpressure is attained.

Finally, the device shown in FIG. 1 includes a regulator 16, which is connected to sensors 3, 4 and control valves 7, 8, and controls them as a function of the measured internal or external pressures such that an additional quantity of air is introduced into space 1 in a targeted manner using pressurized container 5, or an excess quantity of air is drawn out of space 1 in a targeted manner using vacuum container 1. In all, the device shown in FIG. 1 therefore operates primarily as follows:

If sensors 3 and 4 indicate that the external pressure is lower than the internal pressure, and/or that the internal pressure is dropping at an impermissibly fast rate, i.e., a rapid pressure drop, for example, a drop of 500 Pa within 1 sec., control valve 7 is opened and air from pressurized container 5 is released into enclosed space 1. As a result, rapid pressure changes, of this type in particular, in the internal pressure in space 1, which would result in a decreasing internal pressure, are at least partially compensated for via the regulated supply of air, thereby making it possible to react very quickly to fluctuations in the external pressure (rapid pressure changes), as needed, by opening control valve 7 more or less wide.

The system operates so that when a pressure change is detected, the control system ensures that within 1 second, the pressure change is below 500 Pa, within 3 seconds, the pressure change is below 800 Pa and within 10 seconds, the pressure change is below 1000 Pa. For the specific embodiments, different boundary conditions (e.g. size and shape of the enclosed space, pressure and size of the containers provided for compensation, pressure distribution during compensation) may be taken into account.

In a corresponding manner, if sensors 3 and 4 indicate that the external pressure is greater than the internal pressure, and/or that the internal pressure is increasing at an impermissibly fast rate, for example, an increase of 500 within 1 sec., control valve 8 is opened more or less wide to allow air to leave space 1 and enter vacuum container 6, thereby at least partially compensating for a rapid pressure increase in the enclosed space 1. As a result, it is possible to also react very quickly to a rapid increase in the external pressure.

When regulated normally, control valves 7, 8 will always react, depending on a specified control behavior, in the same manner to differences between the external and internal pressure, particularly, rapid pressure changes, to minimize these differences. According to the present invention, however, it is considered to be particularly advantageous to perform regulation in a manner such that the rate of the internal pressure change is at least limited to a value that matches the passengers' tolerance level. As a result, an abrupt pressure equalization that corresponds to the possible rapid fluctuations in external pressure are prevented, and it is ensured that unpleasant pressure may not act on the passengers' ears. This applies for brief pressure fluctuations that last only a few seconds, which could not be compensated for using large, heavy ventilators, pumps, or the like.

Once pressure has been equalized as desired, control valves 7, 8 are closed, flaps 10, 14 are opened, and pressure containers 5, 6 are filled with air or evacuated using ventilators 11 or pumps 15 until a preselected overpressure or underpressure is attained. Flaps 10, 14 may then be closed. Since regulation is normally carried out only at relatively long intervals, e.g., between passages through tunnels, ventilators 11 and pumps 15 may be designed to be relatively small in size. In addition, it is only necessary to move flaps 10, 14 into an opened or closed position using electrical means or other types of means, i.e., there is no need to regulate their particular opening cross section.

Regulator 16, together with sensors 3 and 4, control valves 7 and 8, and containers 5 and 6, form a control device according to the present invention, and may basically have any design, according to FIG. 1, i.e., they may be operated electronically, pneumatically, or in any other manner. For electronic operation, regulator 16 is designed, e.g., as shown in FIG. 2. According thereto, it contains a control unit 18 which is connected to sensors 3, 4, and to which the sensor signals and other types of information may be transmitted, e.g., information on the ground speed, the position of the vehicle, the terrain (e.g., valleys or hills on the route), or the like. Based on this information, a favorable expected value curve is generated, and which is preferably calculated in advance with reference to the known terrain, and it is output at output 19 of control unit 18. The regulation is therefore not carried out based on a fixed expected value, but rather on an expected value that is variable over time.

The expected value curve is constantly compared with the actual value of the internal pressure using a comparator 20, to which the output signals from sensor 3 are also directed. The difference between the two values is sent to a control component 21 which, depending on the case, outputs an actuating signal at an output 22 connected to control valve 7 or at an output 23 connected to control valve 8. Using these actuating signals, control valves 7, 8 are adjusted in a manner such that the desired pressure compensation is attained.

Particularly advantageously, the expected values at output 19 are therefore time-variable guide variables which ensure that control valves 7, 8 are opened wide enough at all times to attain a preselected rate of pressure change in space 1. This means, for example, that, if the external pressure drops rapidly, i.e., a rapid pressure change is detected, control valve 7 is initially opened wide so that, due to a large quantity of air to be supplied, the internal pressure may decrease slowly. Next, control valve 7 may usually then be closed repeatedly, because the difference between the external pressure and the internal pressure becomes less and less, as does the demand for supplied air until the minimum internal pressure, which corresponds to the reduced external pressure, is reached. In particular, the time-variable target pressure curve is selected such that specified comfort criteria (e.g., UIC 660) are approximately maintained under all circumstances.

If it is assumed, with regard for the dimensions of pressurized container 5, that space 1 has a volume of 150 m³, then a pressure drop in space 1 of 1000 Pa/10 s, which is just barely permissible per UIC 660, corresponds via computation to an air mass flow rate of approximately 0.15 kg/s if an adiabatic outflow from pressure container 5 is assumed. If this air mass flow rate should be compensated for entirely from pressure container 5, it must pass through control valve 7. If pressure container 5 is filled, e.g., with air having an overpressure of 2 bar=2·105 Pa, this corresponds to an air mass flow rate of approximately 0.06 m³/sec. Although the outflowing air cools by approximately by 50° C. compared to the temperature in pressure container 5, the advantage results that the air flows into the space very quickly and may therefore be effective even in the case of pressure changes that last only a few seconds or longer. Similar calculations may be carried out for the case in which vacuum container 6 is required to rapidly compensate for pressure spikes. The calculations also show that, under the given circumstances, the volume of pressure container 5, 6 typically must not be greater than, e.g., one percent of the volume of enclosed space 1.

The device shown in FIG. 1 makes it possible to actively regulate the internal pressure in the enclosed space 1 at any time in the presence of elevated external pressures or reduced external pressures. Cases may also exist, however, that only result in an increase or a reduction in internal pressure. In cases such as these, pressurized container 5 or vacuum container 6 and the associated components may be eliminated. A case of this type may occur, e.g., when enclosed space 1 is sealed very well and, therefore, e.g., a reduction in the external pressure due to passage through a tunnel only results in a slower and permissible rate of pressure change in space 1. However, if the vehicle and, with it, well sealed space 1, once the internal pressure of which has been reduced, must then stop at a station located directly after the tunnel, or at a station located in tunnel 1, which is situated in normal external pressure, then pressure may only increase gradually to the higher external pressure, if no special measures are taken. As a result, it may be necessary to keep the vehicle doors closed for a considerable period of time (e.g., 30 s) until the pressure has equalized, to protect the passengers from a pressure shock.

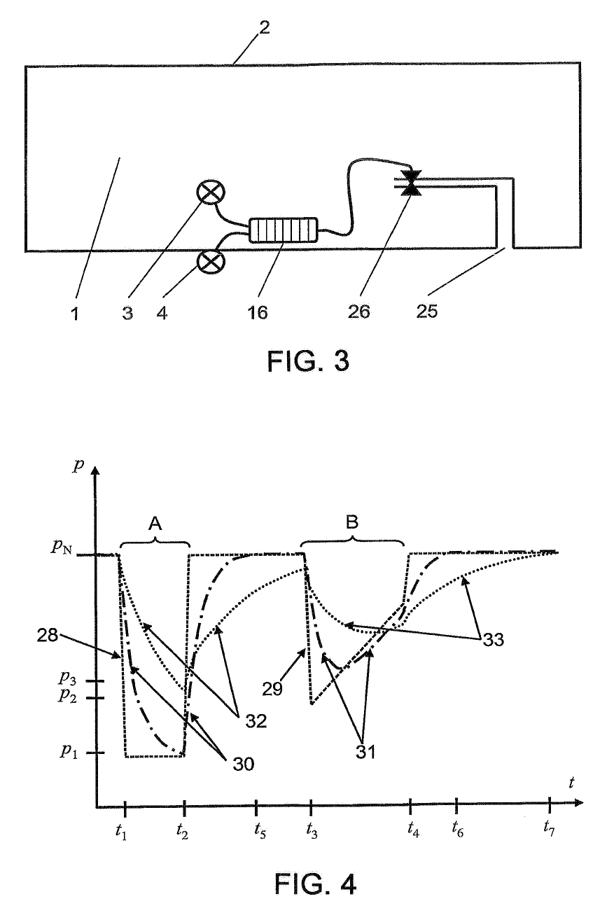

According to the present invention, in a case such as this, the pressure equalization may be accelerated with the aid of the device shown in FIG. 1, or with the aid of a device of the type shown in FIG. 3, in which the same components are labeled with the same reference numerals as in FIG. 1. In contrast to FIG. 1, vehicle wall 2 in this case only includes one opening 25 which leads to the external environment, and which may be opened more or less wide using control valve 26. A control device of the type shown in FIGS. 1 and 2 may be used to regulate the position of control valve 26.

When the device shown in FIG. 3 is used, sensors 3 and 4 indicate a relatively large pressure difference at the end of the tunnel or in an underground train station. As a result, regulator 16 opens control valve 26 in a manner such that the pressure between the outside and the inside equalizes in compliance with the UIC criteria, but it does so at a rate of pressure change that is much greater than would result if space 1, which is assumed to be tight, were left alone. In this manner, the waiting period until the vehicle doors are opened may be reduced considerably, e.g., to a few seconds, and this is basically unnoticeable to the passengers.

FIGS. 4 through 6 show, as examples, a few possible graphs of pressure curves, in which time is plotted on the x-axis, and the pressure is plotted in random units on the y-axis. In addition, pN stands for the normal external pressure in the external environment, which is present, e.g., along an open route traveled by a train. In FIG. 4, it is assumed that a train, which includes a passenger car containing an enclosed space 1, as shown in FIG. 1, is moving along a predefined route and enters a tunnel A at time t1. It is also assumed that the external pressure therefore drops abruptly along a dashed line 28 to a relatively low value p1, which is, e.g., 3000 Pa lower than pressure pN, stays at value p1 as the train passes through the tunnel, and abruptly increases to pN at time t2 when the train exits the tunnel. It is also assumed that, at time t3, the train enters a second tunnel B in which a station is present at which the train comes to a standstill at time t4. In tunnel B, the external pressure initially drops along a dotted curve 29, e.g., only to a value p2, and then assumes normal pressure pN when the train comes to a standstill at time t4.

With respect to PN and P1, the changes occur in less than 1 second but in principle, it is not significant whether this change occurs in 0.1 sec. or in 0.01 sec., as in any case the criteria for the passengers convenience are not met. For that matter, the reader should note that the curves in FIGS. 4 to 6 are not specified with respect to absolute values, but curves 34 and 35 do evidence a compensation which just meets the above defined convenience criteria for 1, 3 and 10 sec.

Furthermore, the course of the internal pressure in a poorly sealed space 1 of the train is shown in FIG. 4 as an example, using dashed curves 30 and 31. As indicated by curves 30, 31, the internal pressure tracks curves 28 and 29 relatively rapidly, i.e., pressure equalization takes place automatically and without much delay. As a result, the internal pressure has reached minimum external pressure p1 at time t2, while, shortly after the train exits tunnel A at time t5, the internal pressure has returned to normal external pressure pN. The pressure changes shown here are so rapid that they are uncomfortable to the passengers. However, the result of space 1 not being tight is that, after the train stops at station B at time t4, the internal pressure returns relatively quickly to normal pressure pN, reaching it at approximately at time t6, and so the vehicle doors may be easily opened at time t6.

FIG. 4 shows, as an example, the course of the internal pressure in space 1 that is sealed relatively well, using dotted curves 32 and 33. As a result, while passing through tunnel A, the internal pressure drops relatively slowly, to point p3, and after tunnel A is exited, the internal pressure increases relatively slowly, until value pN is reached. The same applies for the passage through second tunnel B starting at time t3. As a result of the good sealing of space 1, however, the internal pressure remains below normal external pressure pN for a relatively long period of time once the train has come to a standstill at time t4, as indicated by dotted curve 33; external pressure pN is finally reached at time t7. In this case, the vehicle doors must not be opened at time t4 or at time t6, since there is a risk that the passengers will experience a pressure shock at these instants. It is important to wait until the internal pressure has come sufficiently close to external pressure pN, approximately at time t7.

As described, FIG. 4 shows an embodiment without pressure compensation, wherein the enclosed space is well sealed (curves 32 and 33) and the above defined criteria for the passengers convenience are met. Nevertheless, such a sealing can be costly and unreliable.

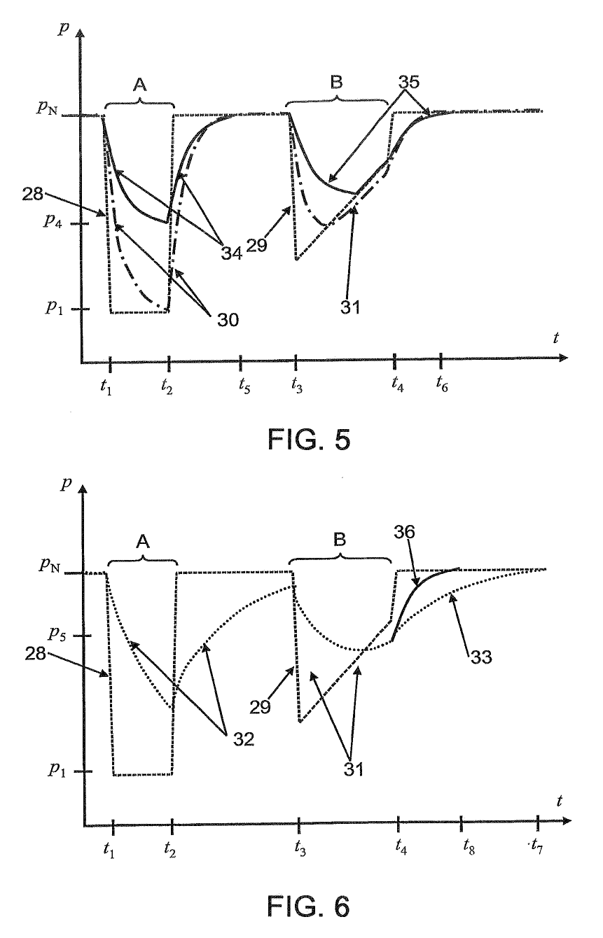

FIG. 5 shows the pressure curves that occur when the internal pressure regulation according to the present invention and described with reference to FIG. 1 is used, in the case of a poorly sealed space 1. In FIG. 5, the same conditions are assumed for the external pressure and the self-adjusting internal pressure as were assumed for FIG. 4 (curves 28, 29 and 30, 31) and, the criteria for the passengers convenience is easily met with an active compensation even for an enclosed space which is not well sealed. However, if, upon entry into tunnel A, the regulation procedure described above takes place, according to the present invention, as soon as the external pressure is sufficiently lower than the internal pressure, then control valve 7 is initially opened, and air is leaves pressure container 5 and enters space 1 so rapidly that the internal pressure drops gradually along a solid curve 34 (FIG. 5), until it reaches value p4. Preferably, the regulation takes place in this range, as described above, in such a manner that the rate of pressure change indicated via the slope of curve 34 never exceeds the passengers' tolerance levels. After tunnel A is exited, control valve 7 may be closed and control valve 8 may be opened, so that air flow out of space 1 and into vacuum container 6 for a period of time, thereby preventing an abrupt increase in the internal pressure to value pN. Advantageously, the regulation is also carried out in this case with consideration for the comfort levels.

Similar pressure curves may be realized in the region of tunnel B, as indicated by solid curve 35 in FIG. 5.

FIG. 6 shows the influence of a device shown in FIG. 3 on the course of pressure in a well-sealed space 1; the same conditions exist in the region of tunnel A as shown in FIG. 4 (curves 28, 29 and 32, 33). Since the comfort level is not exceeded here, in the region of tunnel A, internal pressure regulation is not required.

In contrast, internal pressure regulation in tunnel B is advantageous in this case, using the device shown in FIG. 3. As shown via curve 33, no special measures are required up to approximately time t4. However, at time t4, the internal pressure, having value p5, is much lower than external pressure pN in station B and when the vehicle is at a standstill. Therefore, according to the present invention, control valve 26 shown in FIG. 3 is opened, thereby allowing pressure to equalize rapidly via opening 25 in vehicle wall 2. According to the present invention, although the regulation is also used in this case to control the opening state of control valve 26 in such a manner that the rate of pressure change does not exceed the comfort limit, the increase in internal pressure tracks, e.g., a solid curve 36 shown in FIG. 6. However, the rate of pressure change is selected in this case such that the required pressure equalization is completed at approximately time t8, which is much closer to time t4 (when the vehicle is stopped in station B) than is time t7. The vehicle doors may therefore be opened at time t8 without the passengers experiencing uncomfortable pressure on their ears.

As shown in FIGS. 4 through 6, the distances between tunnels A and B are relatively great under normal circumstances. As a result, it is possible to gradually recharge pressure containers 5 and 6 with compressed air or to evacuate them to the desired level of underpressure between two regulation events. It is also shown that the control device according to FIG. 1 in particular may also be used in cases in which brief or minor leaks are present in space 1. By using the device shown in FIG. 1, it is also possible to tolerate a gradual drop in pressure tightness of the vehicles, within certain limits, as may occur, e.g., over the service life of the vehicles.

The use of the methods and devices according to the present invention is not limited to enclosed spaces of vehicles. Similar problems may also result in conjunction with stationary spaces, e.g., in laboratories used for biological or chemical purposes. It is not typically necessary in these cases to prevent rapid pressure changes of this type that would be perceived as uncomfortable by the individuals working in the laboratories. Instead, it must often be ensured that opening a door or a window briefly, regardless of whether an airlock or the like is present, must not result in air contaminated with harmful substances such as bacteria or viruses escaping to the outside from the space, or entering the space from the outside.

Using the device shown in FIG. 1, it would be possible, even when a door or a window is opened briefly, to ensure via the use of a pressurized container or a vacuum container that a preselected pressure difference between the internal pressure and the external pressure is not exceeded. A main advantage that is attained via the present invention also exists in this case, namely that there is no need to provide oversized and, therefore, complex pumps, fans, or the like, merely to safely maintain a preselected overpressure or underpressure in the space only for the brief period of time when a door or the like is opened. As in the case of space 1 in a vehicle, the advantage also results that pressure container 5, 6 may be made effective very rapidly and no longer require long start-up times, as is the case for a pump or the like.

The present invention is not limited to the embodiments described, which could be modified in various manners. This applies to the size and number of pressure containers 5 and 6 provided per space 1. In the case of large spaces in it may be advantageous to provide several containers 5 and/or 6, to evacuate air or draw it in at various points. Furthermore, it is possible to use as the openings provided in the walls of the space and which lead to the external environment (e.g., 25 in FIG. 3) those openings that are already present in spaces containing air conditioning units, and to possibly equip these openings with control valves.

It is also advantageous to close any other openings that may be present during the times in which the control device described is operating. It is clear that, depending on the case, only one internal pressure sensor 3 is required, even if the additional use of an external pressure sensor 4 is advantageous in many cases, e.g., during the above-described stops in underground stations. Vehicles that continually travel along the same path may also be outfitted with target pressure curves for the control device that are modified especially for this route and that may have been calculated based on experiential values. In addition, the control device, which is composed of sensors 3 (and, possibly, 4), control valves 7, 8 or 26, containers 5, 6, and regulators 16 may basically be realized in many different manners in terms of hardware and software. Finally, it is understood that the features described may also be used in combinations other than those described and depicted herein.

A further embodiment includes application of the FIG. 1 regulator to a cabin of an elevator system. As is known, pressure also changes (is a function of) changing altitude. Especially in large buildings, the corresponding pressure changes in the ascent and descent of a cabin in modern elevator system cannot be neglected. In a certain limit the pressure can be approximated by a linear function, wherein the pressure changes about 12.5 Pa per meter (12.5 Pa/m).

Modern elevator systems reach speeds of up to 10 m/sec. With a constant speed of 10 m/sec., the elevator cabin travels a height of 100 m in 10 seconds. Accordingly, a pressure change of 1250 Pa results, which is in conflict with the limit for the convenience for the passengers, that is, is a rapid pressure change as defined herein.

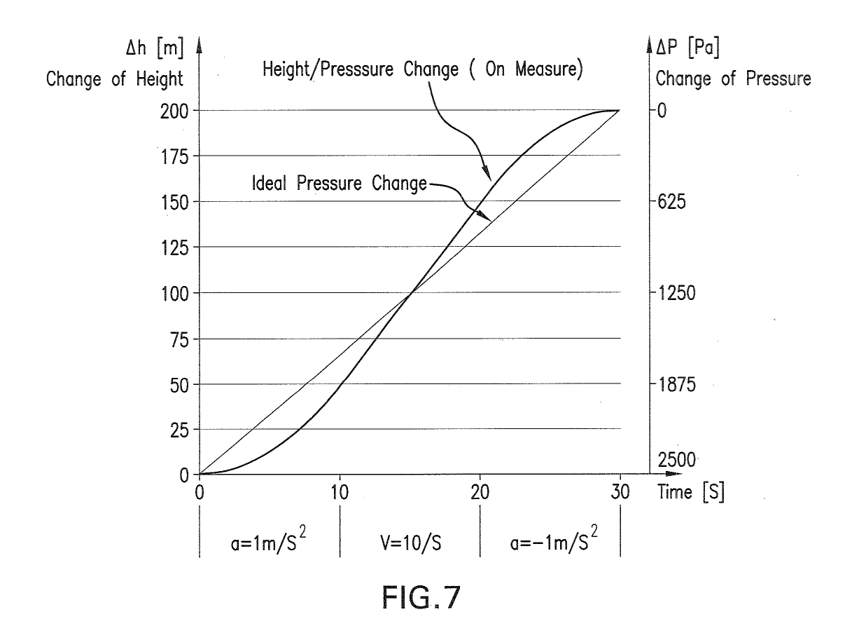

Nevertheless, the acceleration and deceleration of the elevator can be used to reduce the pressure changes in the elevator cabin. FIG. 7 is a chart depicting elevator travel in meters (ordinate axis on the left side) as a function of time in seconds (abscissa axis). The non-linear curve shows the height of the elevator as a function of time. During the first 10 seconds the elevator is accelerated. During the second time interval, between 10 sec. and 20 sec., the elevator cabin travels at its maximum speed of 10 m/sec. In the third interval, between 20 sec. and 30 sec., the elevator cabin is decelerated. Referring to the above mentioned linear dependency, the non-linear curve directly corresponds to the change of pressure without any compensation, wherein the slope of the non-linear curve corresponds to the pressure change (ordinate axis on the right side).

The straight line shows that the convenience criteria can be met when the pressure change is uniform by distributed over the complete period of 30 sec. The regulator system according to the present application allows such a compensation. With respect to the above-described embodiment of a train, the regulator system is used to smooth the pressure changes induced from the outside of the enclosed space. In contrast to this, the regulator system is used together with the elevator system to equalize the unpreventable pressure change during the ascent and descent of the elevator cabin. With respect to an ascent of the elevator cabin, the regulator system actively enhances the change of pressure in the first 15 sec. in such a manner that the criteria for the convenience of the passengers are just met. After 15 sec., the pressure inside the elevator cabin is equal to the ambient pressure at the actual height of the elevator cabin in the middle of the ascent. After 15 sec., the regulator system reduces the pressure in comparison to the ambient pressure. Although the elevator cabin is accelerated, decelerated and travelling at a high constant speed of 12.5 m/sec. in between a linear change of the pressure is achieved that corresponds to a constant speed of 7.5 meters per second and which meets the criteria for the convenience of the passengers.

With respect to the use of the regulator system with the elevator cabin, it is an advantage that the pressure change is coupled to the speed of the elevator cabin and thus at least roughly predictable. Please note that the elements of FIGS. 1-3 may be positioned inside the enclosed space comprising the elevator cabin, that is shared with the passengers, or in a sub-space or compartment provided in the enclosed elevator cabin, within which the elements of FIGS. 1-3 are located.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A method of using a control device for preventing rapid changes in an internal pressure of an enclosed space (1), the rapid pressure changes induced by an external environment, the control device including a first pressure sensor (3) in the enclosed space (1) and a second pressure sensor (4) outside the enclosed space (1), a pressurized container (5) in the enclosed space (1), a vacuum container (6) in the enclosed space (1) and a regulator (16), and the method comprising the steps of:
monitoring the internal pressure of the enclosed space (1) using the first pressure sensor (3) and a pressure external to the enclosed space (1) using the second pressure sensor (4), to detect for rapid changes in the internal pressure, and
using the regulator, at least partially compensating for the detected rapid changes in the internal pressure, by regulating a controlled supply of air to the enclosed space (1) using the pressurized container (5) or a controlled removal of air from the enclosed space (1) using the vacuum container (6) or both.

2. The method as recited in claim 1, wherein the regulating of the supply or removal of air is carried out to maintain a preselected rate of pressure change in the enclosed space (1).

3. The method as recited in claim 1, wherein the regulating is carried out using a preselected target pressure curve for the internal pressure.

4. The method as recited in claim 1, wherein the regulating is carried out with consideration for predefined comfort criteria.

5. The method as recited in claim 2, wherein air is supplied to the enclosed space (1) using at least one control valve (26) which leads to the external environment.

6. The method as recited in claim 1, wherein the enclosed space is a passenger compartment of a trackbound vehicle.

7. The method as recited in claim 1, wherein the enclosed space is an elevator cabin or passenger compartment.

8. A control device for preventing rapid changes in an internal pressure of an enclosed space (1), the rapid pressure changes induced by an external environment, the control device comprising:
a first pressure sensor (3) located in the enclosed space (1);
a second pressure sensor (4) located outside the enclosed space (1);
a pressurized container (5) in the enclosed space (1);
a vacuum container (6) in the enclosed space (1); and
a regulator to at least partially compensate for rapid pressure changes in the enclosed space detected in response to signals generated by the first pressure sensor (3) and the second pressure sensor (4);
wherein if the detected rapid pressure change is a decrease in the internal pressure in the enclosed space, the regulator controls the pressurized container (5) to provide a controlled supply of air to the enclosed space and wherein if the detected rapid pressure change is an increase in the internal pressure in the enclosed space, the regulator controls the vacuum container (6) to effect a controlled removal of air from the enclosed space.

9. The control device as recited in claim 8, further comprising a first control valve (7) and a second control valve (8) and wherein the regulator is designed to regulate the position of the first control valve (7), the second control valve (8) or both.

10. The control device as recited in claim 8, wherein a time-variable guide parameter, which is adapted to a preselected target pressure curve, is relied upon to determine rapid pressure changes.

11. The control device as recited in claim 10, wherein the target pressure curve is plotted with consideration for predefined comfort criteria.

13. The control device as recited in claim 8, wherein the enclosed space is a passenger compartment in a railroad vehicle and wherein the regulator regulates a rate of pressure change in the passenger compartment of the railbound vehicle.

14. The control device as recited in claim 8, wherein the enclosed space is a cabin in an elevator and wherein the regulator regulates a rate of pressure change in the cabin of the elevator.
